(19) United States
(12) Patent Application Publication
(10) Pub. No.: US 2004/0066405 A1
(43) Pub. Date: Apr. 8, 2004

(54) Method and input device for inputting characters from a character set, especially one-handedly

(76) Inventors: Olaf Wessler, Stuttgart (DE); Christian Schröder, Bad Salzuflen (DE)

Correspondence Address: Morriss O'Bryant Compagni, Suite 700, 136 South Main Street, Salt Lake City, UT, 84101, US

(21) Appl. No.: 10/333,885

(22) PCT Filed: Jul. 25, 2001
(86) PCT No.: PCT/EP01/08623

(30) Foreign Application Priority Data
Jul. 26, 2000 (DE) 100 36 421.7

(51) Int. Cl. G09G 5/00

(52) U.S. Cl. 345/764

(57) ABSTRACT

The invention relates to an input device into which characters from a character set can be input, especially one-handedly, and a method for using the input device. The input device includes a display, at least one scrolling device, and at least one key, with at least one part of the character set being displayed on the screen by line and column.

The method is characterized in that a character is input by means of the scrolling device which is used to preselect at least one part of a column, and by means of the at least one key which is used to select a character from a line of the preselected column.

### DESCRIPTION

The invention relates to a method for one-handed input of characters from a character set into a device exhibiting a display, in accordance with the preamble of claim 1, an input device, into which the characters from a character set can be input, in accordance with the preamble of claim 25, as well as an organizer in accordance with claim 44.

Methods for the keyboardless character input by means of a stylus on a display equipped with a touch screen are known. Here, the input is made either by typing on a small keyboard shown on the display or via handwriting recognition. The disadvantage in such methods is that both hands are required and a firm base for the device is needed for reliable input. It consequently becomes quite clear that devices according to this method are marketed as mobile devices, but their operation when used under mobile and moving conditions is hardly possible, since accuracy is needed when using the stylus.

Furthermore, there are efforts to integrate speech recognition into mobile devices, which can be realized in the foreseeable future only with great difficulty due to lack of processor performance and memory capacity in a restricted casing capacity.

Thus, there is currently no satisfactory way one-handed input of text in keyboardless mobile devices, such as organizers (PDA), for example, even though such devices are becoming more widespread.

The task of the invention is to create a method and an input device/a device of the type mentioned at the start, which does not exhibit the above-mentioned disadvantages.

To solve the task, a method with the features of claim 1 is proposed. The method provides for the one-handed input of characters from a character set into a device, in particular a mobile device, which exhibits a display, at least one scrolling device, and at least one key, in which at least a part of the character set is displayed by line and column on the display-preferably on only a part of the display-that the input of a character takes place by means of the scrolling device, which preselects at least one part of a column, and by means of the at least one key that is used to select a character from a line of the preselected column. “One-handed” input is understood as the use of the same hand holding the device to also input the characters. A second hand is therefore not required for this. Furthermore, it is also not necessary to put down the device on a base while inputting the characters.

The device is preferably a mobile device, such as an organizer or a mobile telephone. In the preferred embodiment, it is provided for the device to be keyboardless, i.e., it does not exhibit any keyboard exhibiting the alphabet, as provided in a computer, for instance. This does not refer to the keyboard, in particular, i.e., the number pad of a mobile telephone, in which at least one letter is deposited behind every number or at least some of the numbers, which may be selected when creating an SMS message.

According to a first variation of the embodiment of the method, it is provided for only part of the character set to be shown on the display. In this case, the character set may be moved on the display by means of the scrolling device. According to a second variation of the embodiment, the complete character set is shown on the display, which brings advantages in the search for a particular column, since all the characters are recognizable at a glance without having to operate the scrolling device.

In an advantageous embodiment of the method, the character set fills up the entire display. This facilitates a large presentation of the characters of the character set presented in a matrix exhibiting several columns and at least one line, through which the recognizability of the characters, and consequently, the ease of operation of the device, is improved. However, an embodiment of the method particularly advantageous and preferred it when the character set fills up or occupies only a part of the display so that, in the remaining area of the display, the input characters/character strings or other information and/or functions may be displayed, for example.

Furthermore, an embodiment of the method is preferred, in which only part of the character set is displayed on the display, which may be moved over the entire character set by operating the scrolling device preferably exhibiting at least one scroll wheel and thereby facilitating access to all characters.

According to a further variation of the embodiment, it is provided for the character set to allow for continuous scrolling through, with the start and end being connected with each other. The character set is therefore so large that it can only be shown on the display in sections. In order to select a desired column, it is sufficient to move the character set only in a single direction by means of the scrolling device until the desired column is found on a desired place on the display. Here, it is not necessary to have an awkward scrolling back and forth in order to find a certain character or a certain column.

In a further embodiment, it is provided for the character set to be displayed on the lower margin of the display. This offers the opportunity to display information to be fetched in the part of the display above it or to be stored into the device while character or a character sequence from the character set, or a particular function, for instance a menu selection, is input into the device. In another variation of the embodiment, the character set is displayed in the upper part of the display. It is also easily possible to arrange the character set on one of the side margins of the display. In this case, the character set is moved not parallel or essentially parallel to the lower or upper transversal side of the display, but parallel to the left or right display margin.

According to a further variation of the embodiment, it is possible to zoom in or out of the character set, i.e., to enlarge and reduce. This offers a user the opportunity for individually adjusting the size of the characters to his needs. The display of the character set in the display may be such that, for example, the character set is in the “normal” display mode on the lower margin of the display and that-if desired-this is enlarged or reduced by zooming. The zooming takes place preferably in a stepless manner. It is, of course, easy to also have graduated zooming.

An embodiment of the method, in which the character set is in several lines, preferably shown in three lines, is also preferred. Although the character set exhibiting a number of columns may also exhibit only one line, it has been shown that a multi-line character set offers advantages in the speedy selection and input of a character from the character set. The character set matrix may therefore also exhibit two lines or even more than three lines, such as four or five lines.

In a preferred embodiment, it is provided for one key to be allocated to each line of the character set matrix, by means of which a character is selected from the column preselected using the scrolling device. The advantage in this embodiment is that, after a desired column has been selected using the scrolling device, a very rapid selection of the character in the corresponding line may be made by pressing the corresponding allocated key.

A variation of the embodiment of the method is also preferred in which the column of the character set matrix selected using the scrolling device is visually highlighted through at least one flat bar, often also called a “cursor”. The bar is preferably made up of squares arranged on top of one another or formed therefrom. The advantage here is when the number of squares of the bar corresponds to the number of lines of the character matrix. To select a desired character from the character set, the column exhibiting the character must therefore be congruent with the bar. Only then may the character be selected by pressing a key.

In a variation of the embodiment of the method, it is provided for the selected character to be visually highlighted in the corresponding square of the bar by passing the corresponding key. All the squares of the bar therefore initially exhibit the same color or the same tone or are transparent, in which the color of the square in which the selected character is found may be changed by pressing the corresponding key.

The bar may be fixed in the center of the display, i.e., arranged in a fixed position, with the character set being moved by means of the scrolling device, in particular the scroll wheel. In order to select a certain character, the column within which the character is found must be moved into the bar, with the selection of the character in the corresponding line or in the square subsequently taking place through the at least one key. According to another embodiment of the variation, it is provided for the bar to be moved across the fixed character set by means of the scroll wheel. The character set therefore stays still here, while the bar is moved through the columns of the character set matrix. If the character set is not completely shown in the display, but only in sections, in an advantageous variation of the embodiment, it is provided for the scroll function to switch to the character set by pushing the previously moved bar to the edge of the display, the scroll function switches to the character set which, instead of the bar, is consequently moved when the scroll wheel is operated.

The character set preferably exhibits at least one alphabet segment. The character set may additionally also exhibit special characters, for example, summation symbol, currency symbols, figures, etc. The character set is preferably designed such that the special characters most frequently used border the alphabet segment to the right and left and less commonly used special characters are shown further away from the alphabet segment.

In a preferred embodiment, the character set is designed such that the sequence of the letters in any column in the alphabet segment runs from top to bottom, with the first letter in the alphabet being placed above left. In other words, if the alphabet is in German, the “A” is in the uppermost: square of a first column of the alphabet segment, below it, the “B” in the square of this column, and if it is a 3-line character set matrix, in the lowest square of the first column, the “C”, while the “D”, according to the above-described sequence, is found in the uppermost square of the second column of the alphabet segment.

In order to facilitate a rapid orientation within the character set, in an advantageous variation of the embodiment, an orientation bar is shown on the display, parallel to the character set, which symbolically represents the entire length of the character set, on which a movable mark shows the present position of the alphabet segment in the character set.

An embodiment of the method is also preferred, in which the character set, using the scrolling device, is moved in parallel with respect to the lower or upper display margin, until the desired character appears in the fixed bar in the center, i.e., arranged in a fixed position, as one of several characters arranged on top of the other of the character set matrix.

With respect to the ergonomic handling of the device, it has proven advantageous to set up the scroll wheel to be operated with the thumb of the right hand-looking at the display from top view-on the upper right corner of the device. If the scroll wheel is supposed to be operated with the thumbs of the left hand, the arrangement is to be made correspondingly in mirror image, i.e., the scroll wheel should be arranged in this case on the upper left corner of the device.

In an advantageous embodiment, it is provided for three pushbuttons arranged on top of one another to be provided on the left longitudinal side of a casing of the device-looking at the display from top view-which are operated with the remaining fingers of the same hand, with the pointing finger preferably operating an upper key allocated to the upper square of the bar, the middle finger operating a middle key allocated to the middle square, and the ring finger operating a lower key allocated to the lower square, therefore facilitating direct access to one of the three preselected characters of the 3-line character matrix in the bar.

Finally, an embodiment of the method is preferred, which is distinguished in that some characters or functions that are not shown in the character: set may also be directly selected via additional keys (hotkeys). These hotkeys may be arranged, for example, on the flat side of the device on which the display is found.

Further advantageous forms of embodiment of the method arise from the remaining sub-claims.

To solve the task, an input device with the features of claim 25 is also proposed. Characters from a character set may be input into the input device, preferably one-handedly. The input device includes a display, at least one scrolling device, as well as at least one key, with at least a part of the character set being shown on the display-preferably only on a part of the display-by line or by column, or in the form of a matrix. The input device is preferably designed such that the method is feasible according to one of claims 1 to 23. The input device is characterized by the input of a character taking place by means of the scrolling device, which preselects at least one part of a column of the character set, and which takes place by means of the at least one key, which is used to select a character from a line of the preselected column.

The input device is preferably a mobile device, for example an organizer. The input device may be keyboardless, i.e., there is no keyboard for entering letters from the alphabet. “One-handed” input is understood as the input of the characters also taking place using the hand holding the device, while this hand holds the input device. The input device therefore need not be placed on a base in order to select and input the characters, as is necessary for known input devices.

In a particularly advantageous embodiment of the input device, the scrolling device exhibits a scroll wheel. This facilitates a secure operation with one finger of one hand, with the scroll wheel being arranged preferably on a casing of the input device, in such a way that the thumb may be used in an ergonomical manner for turning. The scroll wheel, which preferably exhibits a knob, facilitates a stepless or grid-linked shifting of the bar and/or the character matrix on the display in one direction or in opposite directions. Through the movement direction specified and defined by means of the scroll wheel, the selection of the character from the character set is simplified in comparison to known operating elements, such as a trackball or a mouse.

According to a development of the invention, it is provided for the scroll wheel to be designed as a pushbutton. For this, a moveable axis is provided for the rotatable mounting of the scroll wheel, which preferably exhibits at least one pressure sensor in the region of the suspension of the axis.

The pressure sensor may alternatively also be arranged in the region of the outer surface of the scroll wheel. The scroll wheel provided with the pressure sensor or that interacts therewith therefore exhibits a double function, since, for one, it serves to select at least one part of a column of the character set matrix, and for another, it selects the character from a line of the preselected column. The advantage here is that a separate key for selecting the character from the preselected column may be dispensed with, if necessary, and the preselection of the column and the selection of the desired character from this column may be performed with the same finger of the same hand, while this hand is simultaneously holding the input device.

In an advantageous embodiment, it is provided for the scroll wheel to be interchangeable and to possibly be designed in different versions in order to facilitate various transmission ratios for the scroll function. Various versions of the scrolling device are also easily possible through revised software so that—insofar as the scrolling device exhibits a scroll wheel—the replacement of the scroll wheel may be dispensed with.

The scrolling device may alternatively or in addition to the scroll wheel, include a touchpad, a trackball, and/or a scroll key. The important thing is that one finger of the hand suffices for scrolling the bar and/or the character set matrix using the operating element, while this hand is simultaneously holding the input device.

An embodiment of the input device is also preferred, in which the input device includes at least the casing exhibiting the scroll wheel, with the casing being designed such that it may be held by one hand of a user and the scroll wheel being arranged such that, in a one-handed operation of the input device, this is operable with the thumb, and the at least one key is operable with at least one of the other fingers of the same hand.

An embodiment of the input device is furthermore preferred, which is characterized by the provision of several keys, which are arranged on the side of the casing and are operated with the remaining fingers of the same hand holding the device. The user therefore need not transfer the grasp from the scroll wheel to the keys but may leave the finger, for instance the thumb, resting on the scroll wheel, while he operates the keys with at least one of the fingers of the same hand.

In a particularly preferred embodiment, the scroll wheel is mounted on the upper corner of the casing so that in the one-handed operation, it may be operated in its natural position by the thumb of the hand holding the casing.

According to a development of the invention, it is provided for the keys provided for one-handed input to be arranged on the side of the casing such that one finger may rest on each key in an ergonomic manner. Here, a particular finger of the hand is preferably allocated to each key. In this form of embodiment, the finger allocated to the scroll wheel and each finger allocated to a key may be left where they are while the input device is being used.

The keys accommodated on the side of the casing may be designed as sensor keys. These are therefore not moved during operation, but respond to pressure, so that they are subject to practically no mechanical wear and tear during operation of the input device.

An embodiment of the input device is also preferred, in which other keys are accommodated on the casing, through which some other characters, if necessary, which are not shown on the character set, for example, an empty space or functions, such as a menu selection, may be entered.

Furthermore, an embodiment is preferred, in which the keys are inserted with context-oriented display lettering in the upper shell of the casing along the transverse side of the upper display.

An embodiment of the input device is furthermore preferred, which is characterized by the display and a selection and input unit containing at least the scrolling device being spatially separate from one another. While the selection and input unit is located on a casing that may be held by one hand, for instance, the display may be placed on an attaché case so that the casing forms a “remote control”, so to speak.

An embodiment of the input device is also preferred, in which at least one of the input elements (scroll wheel, key(s)) necessary for inputting characters from the character set is designed in duplicate in a mirror image arrangement for right and left-hand operation. At least the scrolling device preferably, and preferably also the remaining input elements necessary for inputting or selecting the characters from the character set, are arranged; in a duplicate arrangement. This embodiment facilitates ergonomic operation of the input device for right- and left-handers, and at the same, delimits its variety of variants.

Finally, an embodiment of the input device is preferred, in which the casing exhibits only a slight thickness with respect to its width and length. The casing, which is shaped like a rectangle, for example, is therefore very thin. In a preferred embodiment, it is provided for the casing to more or less correspond to a check/credit card with respect to its measurements. The input device is therefore altogether very small and preferably very light so that it may easily be held even by a relatively small hand, with the fingers of the same hand easily able to operate the scrolling device and the key.

Other advantageous embodiments of the input device arise from the remaining sub-claims.

To solve the problem, an organizer is furthermore proposed with the features according to one of claims 1 to 43. A calendar, an address and/or telephone book, and the like, for example, may be integrated in the organizer. The important thing is that the organizer can be operated with one hand, that is, by the fingers or at least one of the fingers of the hand holding it. To operate the organizer, this therefore need not be placed on a firm base.

According to a development of the invention, the organizer exhibits an interface, by means of which a coupling to an input device, i.e., a personal computer with keyboard, arranged in a stationary manner, for example, is possible. The interface may be an infrared interface or formed by a data cable or the like, for example.

Common to all embodiments of the above-described methods, input devices, and organizers is that, through the appropriate arrangement of the scrolling device or its at least one operating element (scroll wheel, touchpad, trackball, scroll key) and the at least one key for selecting a character from the preselected column in an appropriate arrangement of these able-mentioned operating elements, these may be operated in an ergonomic manner with the same hand also holding the device/input device.

The invention will be explained in greater detail in the following, using the drawing. Shown are:

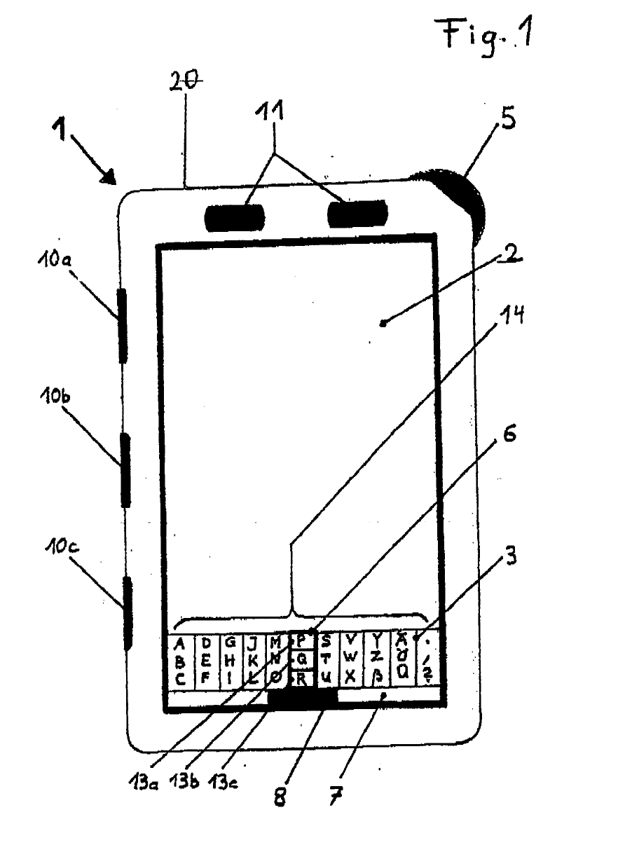

FIG. 1 a top view of an embodiment of an input device for one-handed input of characters of a character set;

FIG. 2 an embodiment of the character set;

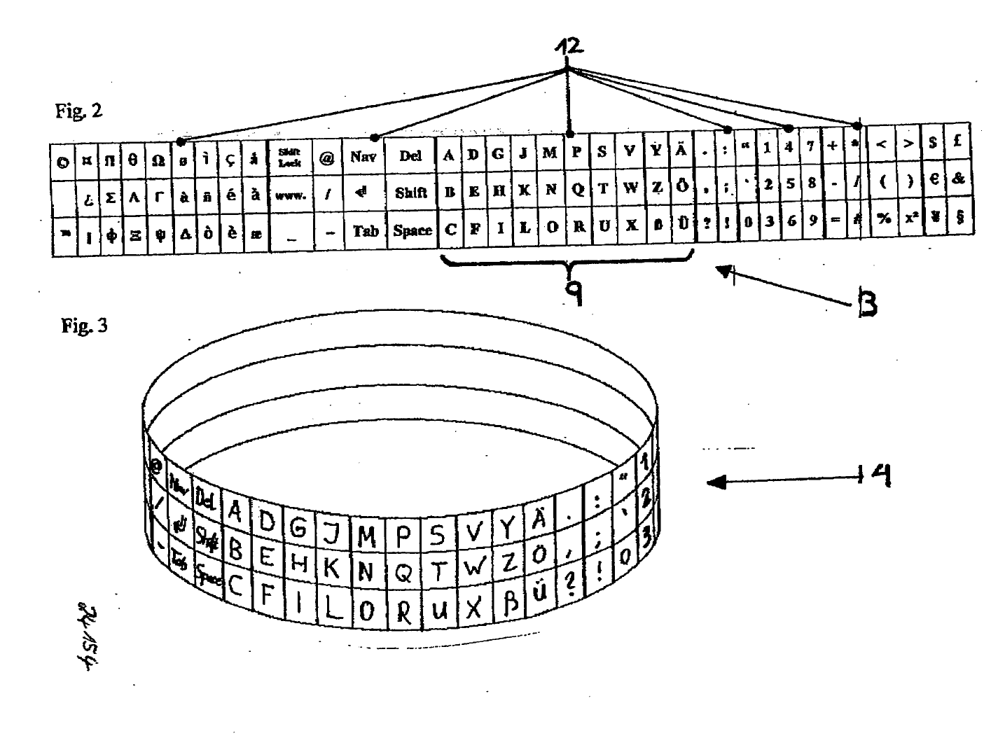

FIG. 3 a perspective representation of the character set illustrated in FIG. 2, whose ends are connected with one another in a virtual continuous strip;

FIG. 4 a section of a character set displayed in a display of the input device, in the starting position; and

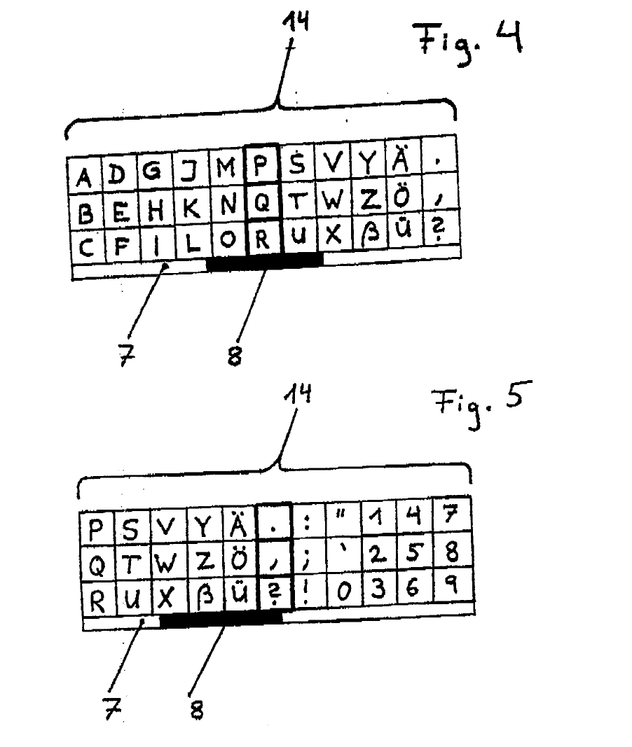

FIG. 5A section of the display, with the character set being moved by scrolling from its starting position.

Input device 1 subsequently described is a keyboardless electronic organizer (Personal Digital Assistant), which will simply be referred to as device in the following, and with which the input method for characters and text according to the invention is practicable.

Device 1; includes casing 20, which here exhibits a rectangular shape when seen from the top, with the corners of casing 20 being rounded. Device 1 has a wide display 2, in whose lower section a part of character set 3 is displayed in three lines. The entire character set 3 is stretched out over the borders of the display for a scale that is easier to recognize, with the start and end being connected with each other in a continuous strip 4 (FIG. 3) This “continuous strip 4” is a virtual strip, and therefore not a three-dimensional strip. “Continuous” means that, for example, in character set 3 shown in FIG. 2, which is designed flat, upon reaching the last column at the right end of character set 3, for example, when scrolling further in the same direction, the very next thing that appears on the left side in the display is the first column. The presentation of continuous strip 4 on the display may be spatial, for example, meaning that continuous strip 4 exhibits such a bend in the display margin areas, as suggested in FIG. 3, for example, thereby optically achieving the impression of a real strip.

Character set 3 may be moved as a whole with the help of a scrolling device exhibiting a scroll wheel 5 in the embodiment illustrated in the figures, until the desired character appears in a bar 6 shown in the center of the display 2. Scroll wheel 5 is rotatable around an axis, not illustrated, which runs vertical to the image plane of FIG. 1 and preferably also to the upper shell of the casing. The scroll wheel 5 arranged on the right, upper corner of the casing partially protrudes over the outer, peripheral surface of the casing so that, using a finger, preferably the thumb, the hand holding the casing may easily be turned directly.

Beneath character set 3 along the transverse side of display 2 is an orientation bar 7, which symbolically represents the entire length of character set 3, on which a marking 8, which moves with character set 3, shows the current position of alphabet 9 in character set 3. By pressing one of the three keys 10a, 10b, 10c laterally accommodated on the left, longitudinal side of casing 20, a character may now be entered. Key 10a is allocated here to the upper character, key 10b to the middle character, and key 10c to the lower character within matrix bar 6, with key 10a being operated by the pointing finger, key 10b by the middle finger, and key 10c by the ring finger. The character entered in such a manner as a result appears in the upper region of display 2 in an application running there. It should be noted that, in this advantageous embodiment, the number of keys 10, which are each allocated to a line of the character set, is the same as the number of lines of character set 3.

Both of the hotkeys 11 installed on the front side of device 1 are context-oriented and are, for example, occupied by the empty character and the menu function.

In such an arrangement of the operating elements and using the above-described method, ergonomic one-handed operation and text input is possible. For the first time, a device 1 is realized, which meets the claim of being operable under mobile conditions, since, ordinarily, one often has only one hand free and has no firm base during mobile use.

In order to facilitate the input, character set 3 is made up of several blocks 12, each of which contains characters of one category. The arrangement of blocks 12 in character set 3 corresponds to the frequency of the use of each character. Thus, for instance, alphabet block 9, which contains all the characters of the alphabet, including umlauts and “β”, in ten columns, is centrally arranged in character set 3 and marks its center. Seldom-needed characters are correspondingly far from this center. Altogether, character set 3 is made up of six blocks 12 with 35 columns in total. To input a character, character set 3, which is proposed for this example, is shown on display 2 in such a way that alphabet 9 and three sets of characters, the period, the comma, and the question mark, for a total of eleven columns, are displayed. The matrix bar 6 shown centrally on display 2 consequently lies above the sixth column with the characters P, Q, and R, and emphasizes these through a border in the form of three squares 13a, 13b, and 13c arranged one on top of the other. A particularly effective and fast text input is made possible through such an arrangement of character set 3.

Character set 3 described using FIG. 1 to represents only one advantageous embodiment. Naturally, in another embodiment of the character set 3, this may also exhibit less than six blocks or, if necessary, even more than six blocks. Here, the number of columns may vary, meaning that it may also easily be more or less than 35. The same applies, too, for the number of lines of the character set matrix, meaning that, in another embodiment of character set 3 not shown in the figures, it is also easily possible for this to exhibit less than three lines, for example, only one line or two lines, but also more than three lines, for instance four or five lines.

As it is apparent from FIG. 1, the outer contour of display 2 is adapted to that of casing 20, meaning that display 2 exhibits a rectangular shape here. With respect to the total area of the upper shell of the casing, display 2 is very large and covers this for the most part.

In an embodiment of input device 1 not shown in the figures, at least the scrolling device, and preferably also the at least one key for selecting the character from the column preselected using the scrolling device, is arranged as a mirror image in a duplicate arrangement. This means that for the embodiment shown in FIG. 1, for example, in addition to the scrolling device arranged in the upper right corner of input device 1, which here includes scroll wheel 5, on the upper left corner of the casing, there is yet a second, preferably identically designed scrolling device and additional keys 10a to 10c protruding on the right, longitudinal side of the casing, if necessary. With each of the scrolling devices, a column may then be selected from the character set and by means* the two keys 10a or 10b or 10c, a character may be selected from the corresponding line of the pre-selected column.

Input device 1 described with the help of the figures is a mobile device, i.e., it can be taken practically anywhere. Input device 1 may, for instance, also be a mobile telephone or the like.

1. A method for one-handed input of characters from a character set (3) into a (preferably keyboardless) device (1), in particular a mobile device, having a display (2), at least one scrolling device, and at least one key (10a, 10b, 10c), in which at least a part of the character set (3) is displayed by line and column on the display (2), characterized in that the input of a character takes place by means of the scrolling device, which preselects at least one part of a column, and by means of the at least one key (10a, 10b, 10c) that is used to select a character from a line of the preselected column.

2. The method according to one of the previous claims, characterized in that the complete character set (3) is shown on the display (2).

3. The method according to one of the previous claims, characterized in that the character set (3) fills up the entire display (2).

4. The method according to one of the previous claims, characterized in that the character set (3) may be zoomed, preferably in a stepless manner.

5. The method according to one of the previous claims, characterized in that the character set (3) is shown in several lines, preferably three lines.

6. The method according to one of the previous claims, characterized in that one key (10a; 10b; 10c) is allocated to each line.

7. The method according to one of the previous claims, characterized in that only a section (14) of the character set (3) is shown on the display (2), which can be moved over the entire character set by operating the scrolling device preferably exhibiting at least one scroll wheel (5) and thereby facilitating access to all characters.

8. The method according to one of the previous claims, characterized in that the character set (3) is shown preferably on the lower margin of the display (2), on the upper margin, and or on at least one of the side margins of the display (2).

9. The method according to one of the previous claims, characterized in that the character set (3) allows for continuous scrolling through, with the start and end being connected with each other.

10. The method according to one of the previous claims, characterized in that the column of the character set matrix (3) selected using the scrolling device is shown visually highlighted through at least one flat bar (6).

11. The method according to one of the previous claims, characterized in that the bar (6) is made up of squares (13a, 13b, 13c) arranged one on top of the other or is formed therefrom.

12. The method according to one of the previous claims, characterized in that the number of squares (13a, 13b, 13c) of the bar (6) corresponds to the number of lines of the character set matrix (3).

13. The method according to one of the previous claims, characterized in that the character selected by pressing a key is visually highlighted in the corresponding square (13a, 13b, 13c) of the bar (6).

14. The method according to one of the previous claims, characterized in that the bar (6) is fixed in the center of the display (2) and the character set (3) is moved by means of the scroll wheel (5).

15. The method according to one of the previous claims 1 to 13, characterized in that the bar (6) is moved across the fixed character set (3) through the scroll wheel (5).

16. The method according to one of the previous claims, characterized in that in pushing the previously moved bar (6) to the edge of the display (2), the scroll function switches to the character set (3), which, instead of the bar (6), is consequently moved when the scroll wheel is operated.

17. The method according to one of the previous claims, characterized in that the character set (3) includes at least an alphabet segment (9) and special characters, and that the character set (3) is designed such that the special characters most frequently used border the alphabet segment (9) to the right and left, and less commonly used special characters are shown further away from the alphabet segment (9).

18. The method according to one of the previous claims, characterized in that the character set (3) is designed in a form in which the sequence of the letters in any column in the alphabet segment (9) runs from top to bottom, with the first letter of the alphabet being placed above left.

19. The method according to one of the previous claims, characterized in that an orientation bar (7) is shown on the display (2), parallel to the character set (3), which symbolically represents the entire length of the character set (3), on which a movable mark (8) shows the present position of the alphabet segment (9) in the character set (3).

20. The method according to one of the previous claims, characterized in that the scrolling device to be operated with the thumb of the right hand, in particular the scroll wheel (5), is arranged preferably on the upper right corner of the device and the character set (3)—depending on the arrangement of the character set in the display—moves preferably parallel to the upper and lower or left and right display margin respectively, until the desired character, as one of several characters arranged on top of one another of the character set matrix (3), appears in the fixed bar (6) in the center.

21. The method according to claim 20, characterized in that when looking at the display from above, three keys (10a, 10b, 10c) arranged one on top of the other are provided on the left longitudinal side of a casing (20), which are operated with the remaining fingers of the same hand, with the pointing finger preferably operating an upper key (10a) allocated to the upper square (13a) of the bar (6), the middle finger operating a middle key (10b) allocated to the middle square (13b), and the ring finger operating a lower key (10c) allocated to the lower square (13c), which facilitates a direct access to one of the three preselected characters in the bar (6).

22. The method according to one of the previous claims, characterized in that some characters or functions that are not shown in the character set (3) may also be directly selected via additional keys (11).

23. The method according to one of the previous claims, characterized in that the character set (3) is used according to FIG. 2.

24. The method according to one of the previous claims, characterized in that an entire column is selected using the scrolling device.

25. An input device (1), in particular a mobile device, into which characters from a character set (3) may be input, preferably one-handedly, including a display (2), at least one scrolling device, as well as at least one key (10a, 10b, 10c), with at least a part of the character set (3) being shown on the display (2) by line and column, in particular for executing the method according to one of claims 1 to 24, characterized in that the input of a character takes place by means of the scrolling device, which preselects at least one part of a column, and by means of the at least one key that is used to select a character from a line of the preselected column.

26. The input device according to claim 25, characterized in that the scrolling device includes a scroll wheel (5).

27. The input device according to one of the previous claims, characterized in that the scroll wheel (5) is designed as a push button.

28. The input device according to one of the previous claims, characterized by a movable axis for the rotatable mounting of the scroll wheel (5).

29. The input device according to one of the previous claims, characterized by at least one pressure sensor in the region of the suspension of the axis.

30. The input device according to one of the previous claims, characterized in that the pressure sensor is arranged in the region of the outer surface of the scroll wheel (5).

31. The input device according to one of the previous claims, characterized in that the scrolling device includes a touchpad, a trackball, and/or a scroll key.

32. The input device according to one of the previous claims, characterized in that the display (2) and a selection and input unit containing at least the scrolling device are spatially separate from one another.

33. The input device according to one of the previous claims, characterized by a casing (20) exhibiting at least the scrolling device, in particular the scroll wheel (5), the casing being possible to hold in one hand of a user, with the scrolling device, in particular the scroll wheel (5), being arranged such that in a one-handed operation of the input device (1), the scrolling device, in particular the scroll wheel (5), is operable with the thumbs, and the at least one key (10a, 10b, 10c) is operable with at least one of the other fingers of the same hand.

34. The input device according to one of the previous claims, characterized in that several keys (10a, 10b, 10c) are arranged laterally on the casing (20) and are operated with the remaining fingers of the same hand holding the casing (20).

35. The input device according to one of the previous claims, characterized in that the number of keys is the same as the number of lines of the character set.

36. The input device according to one of the previous claims, characterized in that the scrolling device, in particular the scroll wheel (5), is mounted on the upper corner of the casing (20), so that in the one-handed operation, it may be operated in its natural position by the thumb of the hand holding the casing (20).

37. The input device according to one of the previous claims, characterized in that the keys (10a, 10b, 10c) provided for the one-handed input are arranged on the side of the casing (20) such that one finger may rest on each key in an ergonomic manner (10, 10b, 10c).

38. The input device according to one of the previous claims, characterized in that hotkeys (11) are placed on the casing (20), through which some other characters, if necessary, which are not shown on the character set (3), for example an empty space, or functions, may be entered directly.

39. The input device according to one of the previous claims, characterized in that the hotkeys (11) are inserted with context-oriented display lettering in the upper shell of the casing along the transverse side of the upper display.

40. The input device according to one of the previous claims, characterized in that the scroll wheel (5) is exchangeable and may be designed in different versions in order to: facilitate various transmission versions for the scroll function and/or to realize various transmission ratios for the scroll function through an appropriately revised software.

41. The input device according to one of the previous claims, characterized in that the keys (10a, 10b, 10c, 11) are designed as sensor keys.

42. The input device according to one of the previous claims, characterized in that the input elements (5, 10a, 10b, 10c) necessary for inputting characters of the character set (3) are also executed in duplicate in a mirror image arrangement for right and left-hand operation.

43. The input device according to one of the previous claims, characterized in that the casing (20) exhibits only a slight thickness with respect to its width and length.

44. An organizer (PDA, Personal Digital Assistant) with the features according to one of claims 1 to 43.
